(19) United States
(12) Patent Application Publication
(10) Pub. No.: US 2005/0201346 A1
(43) Pub. Date: Sep. 15, 2005

(54) Systems and methods for broadband data communication in a wireless mesh network

(76) Inventors: Weilin Wang, San Diego, CA (US); Michael P. Nova, Del Mar, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/095,349

(22) Filed: Mar. 31, 2005

Related U.S. Application Data
(63) Continuation-in-part of application No. 10/437,128, filed on May 13, 2003.
(63) Continuation-in-part of application No. 10/437,129, filed on May 13, 2003.
(63) Continuation-in-part of application No. 10/816,481, filed on Apr. 1, 2004.
(60) Provisional application No. 60/557,954, filed on Mar. 31, 2004.

(51) Int. Cl. H04Q 7/24

(52) U.S. Cl. 370/338

(57) ABSTRACT

Systems and methods for reducing congestion in a wireless communication network are provided. In one aspect, an improved MAC layer protocol is provided that allows channel switching for data communications over a wireless network on a frame by frame basis allowing increased use of spectrum and significantly reducing congestion. Additionally, throughput is increased and battery life is conserved by reducing the power level for an RTS message to the minimum power needed to reach the recipient node. The corresponding CTS message is then sent by the recipient node and the range of the CTS message is sufficient to inform other nodes in the network that the recipient is not available for communication. This method allows other nodes in the network to remain free to communicate with each other. Moreover, the minimum power level needed to send an RTS message to each node may be maintained in a local routing table or other data storage area on the wireless communication device.

### RELATED APPLICATION

The present application claims the benefit of U.S. provisional patent application Ser. No. 60/557,954 filed on Mar. 31, 2004, entitled “Broadband Applications for Wireless Mesh Networks” and is a continuation-in-part of U.S. patent application Ser. No. 10/437,128 and U.S. patent application Ser. No. 10/437,129 and U.S. patent application Ser. No. 10/816,481, each of which is incorporated herein by reference in its entirety.

### BACKGROUND

1. Field of the Invention

The present invention generally relates to wireless communication networks and more specifically relates to broadband applications for wireless mesh networks including wireless wide area networks, wireless local area networks, and mobile ad hoc wireless networks.

2. Related Art

The IEEE 802.11 MAC protocol is not well suited for multi-hop wireless networking environments such as that found in a wireless mesh network. In particular, the utilization of the spectrum is extremely poor. For example, in an 802.11b network, spectrum utilization can be as low as 33% of the available channels, while in an 802.11a network, that number plummets to as low as 12.5% of the available channels.

In addition to this, channel switching in a conventional 802.11 wireless network ranges in time from ½ second to 1 full second. Such slow and cumbersome channel switching effectively limits data communications to a single channel in a conventional 802.11 wireless communication network, which minimizes spectrum utilization.

Additional drawbacks of conventional 802.11 wireless networks include the implementation of TCP in the protocol stack. The transport communication protocol was not designed for wireless communication networks that employ ephemeral (on/off) connections between nodes. Connections may appear to be lost due to a temporary obstruction or a slight dip in signal strength. TCP interprets these lost connections as network congestion and accordingly implements a backing off algorithm while continuing to communication over the lost channel. There are many additional factors that contribute to the overall problems with TCP over wireless, such as path asymmetry, route blackout, random packet loss, and high varying delays, just to name a few.

These and other challenges of wireless communication networks have made implementation of commercial solutions and products over ad hoc wireless mesh networks a significant challenge. For example, one challenge is the scalability of an ad hoc mesh network because the throughput of a network cannot exceed 1/sqrt(n), where n is the number of nodes in the multi-hop network. There are also fundamental tradeoffs between the hop count of a communication path and the transmission range. Obviously, increasing the transmission range will result in fewer hops, but doing so will also cause more interference. Thus, a number of research papers have concluded that the optimum node density is about 6 neighbors/node (e.g., Leonard Kleinrock, “Why 6 is the Magic Number”).

Therefore, what is needed is a system and method that overcomes these significant problems found in the conventional systems as described above.

### SUMMARY

The present invention provides systems and methods for reducing congestion and perceived congestion in a wireless communication network. The invention provides an improved media access control (“MAC”) layer protocol that allows channel switching for data communications over a wireless network on a session by session basis and optionally on a frame by frame basis. The time it takes for two nodes in a wireless communication network to switch communication channels is reduced to nearly electronic speed. Thus, through the use of additional spectrum, congestion is significantly reduced.

Furthermore, throughput is increased and battery life is conserved by reducing the power level for a request to send (“RTS”) message to the minimum power needed to reach the recipient node. The corresponding clear to send (“CTS”) message is then sent by the recipient node and informs other nodes in the network that the recipient is not available for communication such that the other nodes in the network remain free to communicate with each other. Additionally, the minimum power level to send an RTS message to each node may be maintained by a node in a local routing table or other data storage area.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example wireless mesh network according to an embodiment of the present invention;

FIG. 2 is a block diagram illustrating an example 802.11 physical layer and medium access control layer according to an embodiment of the present invention;

FIGS. 3A-3B are communication diagrams illustrating example communications between nodes in a wireless communication network according to an embodiment of the present invention;

FIG. 4 is a communication diagram illustrating an example prior art request to send message;

FIGS. 5A-5B are communication diagrams illustrating example request to send and clear to send messages exchanged by two nodes in a wireless communication network according to an embodiment of the present invention;

FIG. 6 is a block diagram illustrating an example routing table according to an embodiment of the present invention; and

FIG. 7 is a block diagram illustrating an exemplary wireless communication device 450 that may be used in connection with the various embodiments described herein.

### DETAILED DESCRIPTION

Certain embodiments as disclosed herein provide for systems and methods for reducing congestion in an ad hoc wireless communication network. For example, one method as disclosed herein allows for a transmitting node to send the frames of a data communication over a plurality of channels in the wireless communication network, thus significantly reducing congestion through the increased use of spectrum.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

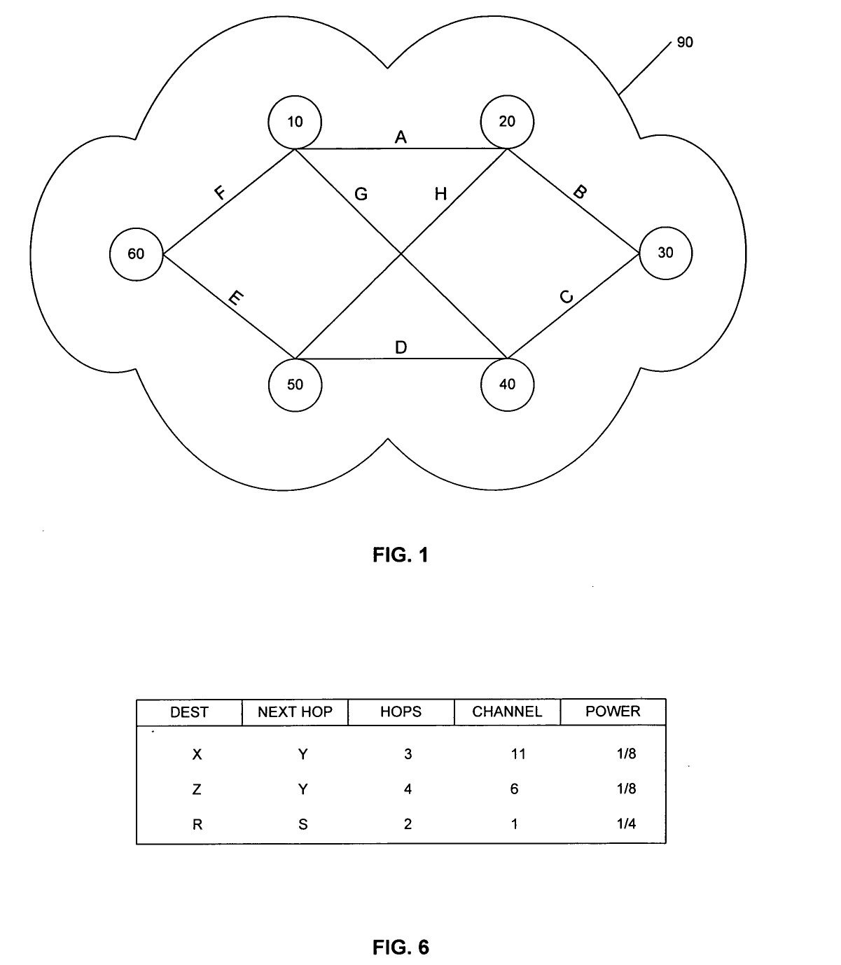

FIG. 1 is a network diagram illustrating an example wireless mesh network 90 according to an embodiment of the present invention. In the illustrated embodiment, the network 90 comprises a plurality of wireless communication devices (also referred to herein as “nodes” or “wireless devices”) such as nodes 10, 20, 30, 40, 50, and 60. Additionally illustrated are several wireless communication paths (also referred to herein as “links”) between the various nodes, for example link A between node 10 and node 20. A path may also comprise a plurality of links, such as the path between node 10 and 20 that includes links F, E, and H, or alternatively, links G, D, and H. Such conventional communications between nodes in wireless communication network (also referred to herein as an “ad hoc network” or “wireless network” or “wireless ad hoc network” or “mesh network” or some combination of these) will be understood by one having skill in the art.

Furthermore, each node in the illustrated diagram has a maximum communication distance within the wireless communication network. This distance is not shown, however, but can be understood such that node 30 can not directly communication with node 60 and vice versa. Accordingly, there may be some unidirectional communication capability, for example, node 20 can communicate via link H with node 50 and seems to have the ability to communicate with node 40. However, the maximum distance for direct communication from node 40 does not include node 20, and therefore no direct link between the two nodes is present.

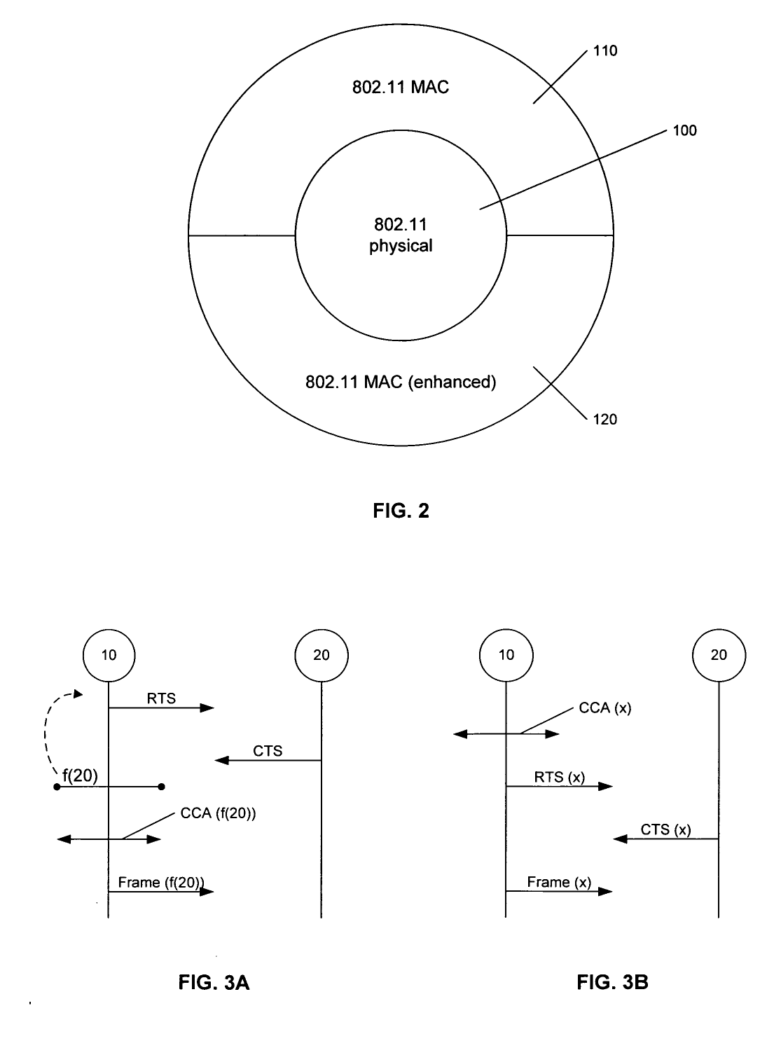

FIG. 2 is a block diagram illustrating an example 802.11 physical layer 100 and medium access control (“MAC”) layer according to an embodiment of the present invention. In the illustrated embodiment, the MAC layer is divided into two segments. Segment 110 represents the conventional 802.11 MAC protocol while segment 120 represents the enhanced portion of the 802.11 MAC protocol that provides for the ability to switch communication channels on a frame by frame basis during data communication and the other advantages of the present invention.

FIG. 3A is a communication diagram illustrating an example communication between nodes in a wireless communication network according to an embodiment of the present invention. In the illustrated embodiment, node 10 needs to send a data communication to node 20. Initially, node 10 sends an RTS packet as a broadcast over a control channel with the recipient designated as node 20. As will be understood by one having skill in the art, an RTS packet is a very small communication and therefore its successful delivery over the contention based control channel is highly likely. A contention based channel is one where nodes spontaneously communicate without first checking to see if they can exclusively reserve the channel or checking to see if the channel is free.

The RTS packet is broadcast in every direction away from node 10 and when it is received by node 20, node 20 responds with a corresponding CTS packet, which acknowledges that node 20 is ready to receive a data communication from node 10. Prior to sending the data communication, node 10 preferably performs a channel selection function using the address of node 20 as input in order to determine what channel the ensuing data communication should be sent over. Once the channel is determined (as output of the function), node 10 performs a clear channel assessment on the channel and if the channel is clear, sends the data frame to node 10 over the selected channel.

Alternatively, prior to sending the RTS packet, node 10 may perform the channel selection function so that it may immediately check assess the selected channel up on receipt of the CTS packet from node 20. This can advantageously speed up communications between the two nodes.

Although not shown in the figure, after node 20 sends the CTS packet, it preferably also performs the channel selection function using its address as input. This allows node 20 to determine the channel on which it should expect to receive a data communication from node 10. Node 20 may thereafter listen on that channel for the ensuing communication from node 10. In one embodiment, if no communication from node 10 is receive in a certain amount of time (i.e., a “timeout” condition occurs) then node 20 may perform the same channel selection function using a different input value.

Advantageously, a list of input values may be agreed upon in advance by the nodes in a mesh network such that they can cycle through the channel selection function using the same input value in order to individually arrive at the same channel selection. For example, the first input value may be the address of the receiving node. The second input value may be the address of the sending node, the third input value may be the sum of the sending node and receiving node addresses, and so on. In this way, the nodes can send individual frames to each other during data communication without the added overhead of additional communications in order to collectively select a particular channel.

FIG. 3B is a communication diagram illustrating an example communication between nodes in a wireless communication network according to an embodiment of the present invention. In the illustrated embodiment, node 10 needs to send a data communication to node 20. Initially, node 10 performs a clear channel assessment on a selected channel x. The channel selection in this example can be random or the result of a particular function. Advantageously, this example does not require a synchronized algorithm between the two nodes to select a channel because the sending node identifies an available channel prior to sending the RTS packet.

In the illustrated embodiment, the RTS packet itself, while remaining very small indeed, includes the selected channel for communication. Accordingly, when node 20 receives the RTS packet over the control channel it responds with a CTS packet acknowledging that the selected communication channel is x. Because the communication channel has already been identified as clear, and the round trip time for the RTS/CTS packets is negligible, node 10 may immediately send the data communication frame to node 20 over the selected channel.

This particular method also applies to mid-stream data communication. For example, to optimize the successful delivery of large frames of data in a wireless mesh network, it is advantageous to perform a clear channel assessment prior to sending any large frame. Additionally, an RTS/CTS combination is also advantageous prior to sending any large frame. Accordingly, by slightly modifying the RTS/CTS communication to include the selected channel for the ensuing frame, channel switching in a wireless mesh network may be implemented by the MAC layer on a frame to frame basis without adding any significant overhead to the communications. Thus, communications in the wireless mesh network are very significantly improved by increased use of the available spectrum (maximizing use of the available channels) and total throughput is significantly increased (allowing for the successful implementation of simultaneous multimedia broadband applications such as streaming video or multi-player gaming).

Advantageously, the increased spectrum use facilitates high bandwidth applications and protocols such as data streaming applications and protocols, security applications and protocols, building automation applications and protocols, energy management applications and protocols, supply chain management applications and protocols, logistics applications and protocols, sensor data applications and protocols, and many others.

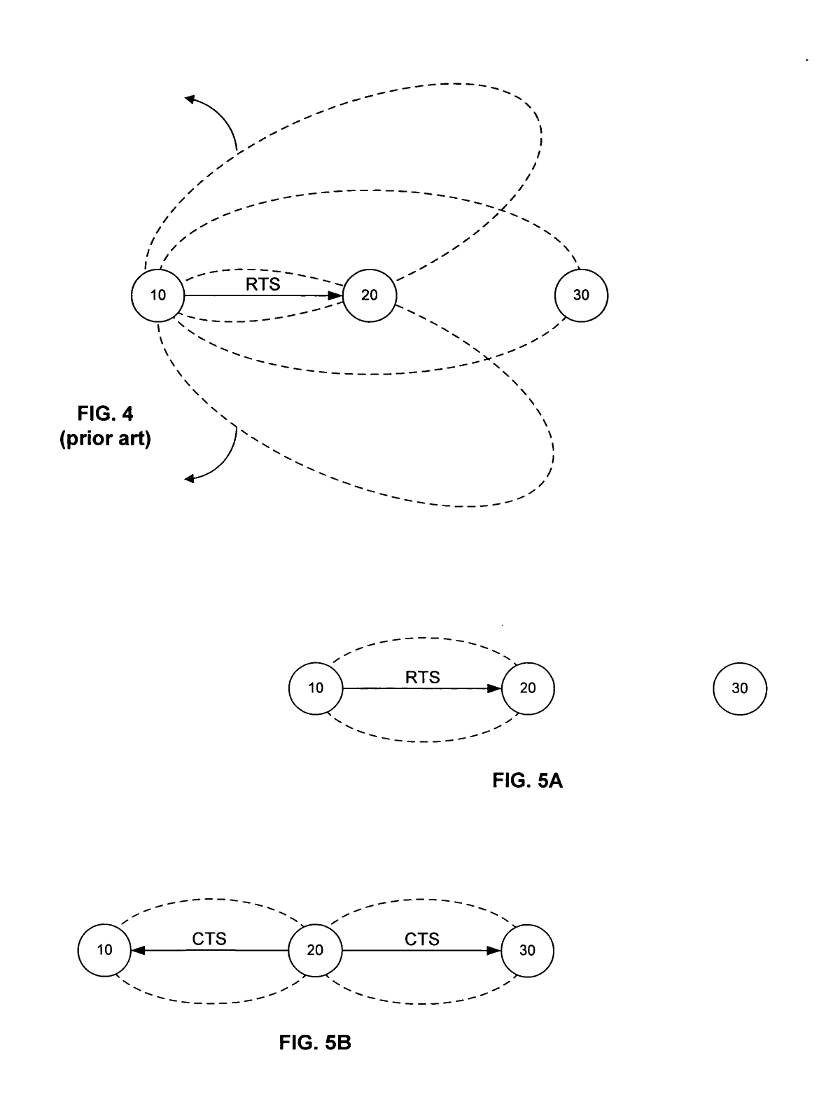

FIG. 4 is a communication diagram illustrating an example prior art request to send message. In the diagram, the RTS packet is sent by node 10 and destined for node 20. As will be understood by one having skill in the art, the dashed lines represent the range of the RTS packet and the arrows indicate that the RTS packet is broadcast in all directions.

According to conventional implementations of 802.11 wireless networks, the sensing range of a node is much larger than the interference range. For example, the sensing range can be twice as large as the interference range. Therefore RTS/CTS in one cell will inhibit transmissions in all neighboring cells. This is because 802.11 wants to suppress communications from other nodes that are in range of node 20 once node 10 has initiated a request to send a communication to node 20. A disadvantage of the suppression in communications is that it applies to those nodes in range of the RTS packet and prevents them from communicating with other nodes that are not involved (i.e., nodes other than 10 and 20). This results in a significant overall degradation in throughput on the wireless network.

For example, when node 10 sends its RTS packet, the packet is received by both node 20 and node 30. While node 20 responds to the RTS packet, node 30 remains idle for a period so that any packets that it may send over the wireless network do not interfere with the communication between node 10 and 20. This prevents node 30 from communicating with another node, e.g., 40 (not shown) that may be in close proximity to node 30 such that communications between 30 and 40 would not physically interfere with communications between node 10 and 20, even if they were on the same channel at the same time.

FIG. 5A is a communication diagram illustrating an example request to send message sent in a wireless communication network according to an embodiment of the present invention. In the illustrated embodiment, the range of the RTS packet (represented by the dashed line) is optimized to reach node 20 and not go further. Although not illustrated, it is understood that the RTS packet is broadcast in all directions. Optimizing the range of the packet has at least two very beneficial effects: (1) other nodes in the mesh network are not unnecessarily prevented from communication; and (2) battery power on node 10 is conserved.

FIG. 5B is a communication diagram illustrating an example clear to send message sent in a wireless communication network according to an embodiment of the present invention. In the illustrated embodiment, node 20 is responding to the RTS packet sent by node 10 in FIG. 5A. In the responsive CTS packet, which node 20 broadcasts in all directions, an acknowledgement that node 10 is cleared to send a data communication to node 20 is included. This acknowledgement prevents other nodes in the mesh network, such as node 30, from sending communications to node 20 that may cause interference with the communication between node 10 and 20, while at the same time, indicating that node 30 may communicate with other nodes in the mesh network. Accordingly, the overall throughput in the mesh network is increased by eliminating the suppression of communications pursuant to the overcasting of RTS packets as called for in the conventional 802.11 protocol.

FIG. 6 is a block diagram illustrating an example routing table according to an embodiment of the present invention. Advantageously, a node in the mesh network may maintain a routing table of nodes that it is aware of. The routing table preferably contains useful information such as the number of hops to reach the destination node, the very next hop in the path to reach the destination node, a preferred communication channel for the destination node, and a power level for the destination node. The power level preferably indicates the power level at which to broadcast an RTS packet when initiating communications with the recipient node. Thus, by maintaining a table of information including the power level for the RTS packet, the node can save significant battery power by reducing the power (by roughly half) on all of the RTS packets that the node sends over its lifetime.

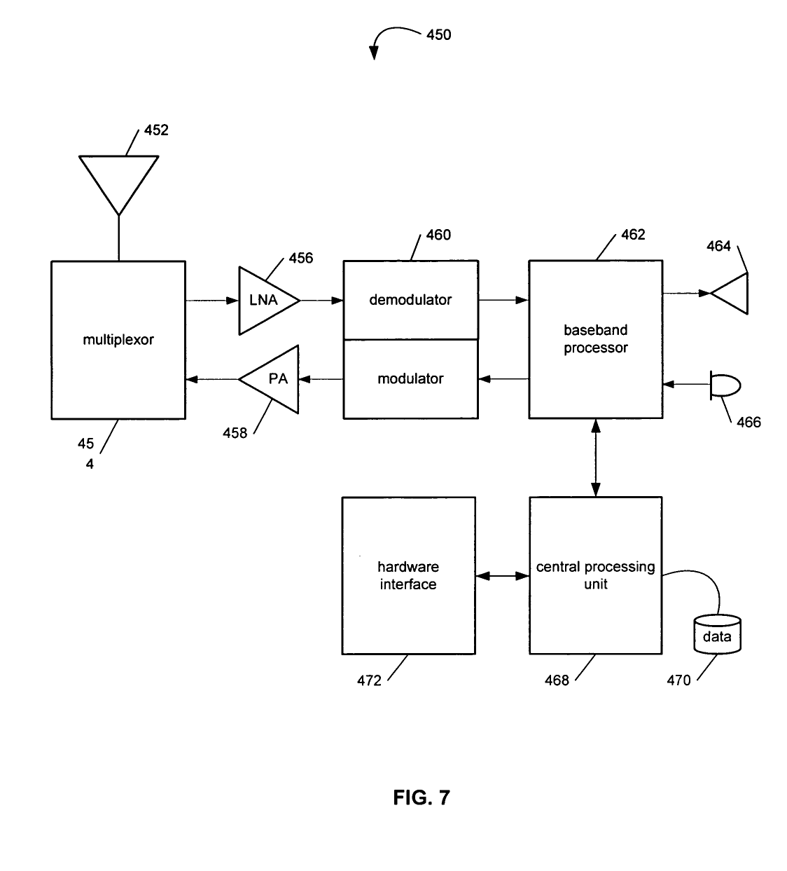

FIG. 7 is a block diagram illustrating an exemplary wireless communication device 450 that may be used in connection with the various embodiments described herein. For example, the wireless communication device 450 may be used in conjunction with a node in an ad hoc wireless communication network. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

While the particular systems and methods herein shown and described in detail are fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A system for high bandwidth throughput in a wireless communication network, comprising:
a wireless mesh network;
a plurality of network device communicatively coupled to the mesh network, wherein each network device is configured to communicate with at least one other network device via the wireless mesh network;
wherein inter-device data communication implements a high bandwidth computer executed application.

2. The system of claim 1, wherein the application is a multi-player video game.

3. The system of claim 2, wherein the inter-device data communication comprises audio data related to the video game.

4. The system of claim 1, wherein the inter-device data communication comprises voice data originating from a user of a network device.

5. A system for radio frequency identification, comprising:
an ad hoc wireless mesh network;
a plurality of radio frequency identification modules, each module attached to a predetermined item and configured to communicate with at least one other module over the ad hoc wireless mesh network;
wherein data communication between the modules over the ad hoc wireless mesh network provides status information related to each predetermined item.

6. The system of claim 7, wherein the status information comprises location information

7. The system of claim 7, wherein the status information comprises logistics information

8. The system of claim 7, wherein the status information comprises position information

9. The system of claim 7, wherein the status information comprises supply chain management information.

10. A system for modifying the physical domain of an ad hoc wireless mesh network, comprising:
an access point configured to bridge traffic from an ad hoc wireless mesh network to another network;
a plurality of repeater points, each repeater point adaptable to receive power from a standard power source, each repeater further configured to route data communication traffic on the ad hoc wireless mesh network to the access point or one of the plurality of repeater points, said data communication traffic including radio signal receive power information, number of repeater points between a repeater point and the access point, best rout performance, and real-time performance metrics; and
a plurality of network devices, each network device configured for data communication over the ad hoc wireless mesh network, wherein the physical domain of the ad hoc wireless mesh network is modified by placing an additional repeater point within wireless communication range of the access point or one of the plurality of repeater points.
